(19) United States
(12) Patent Application Publication
(10) Pub. No.: US 2012/0082898 A1
(43) Pub. Date: Apr. 5, 2012

(54) METHOD FOR PRODUCING NONAQUEOUS ELECTROLYTE SECONDARY BATTERY AND NONAQUEOUS ELECTROLYTE SECONDARY BATTERY

(75) Inventors: Yasufumi Takahashi, Kobe-shi (JP); Masahisa Fujimoto, Osaka (JP)

(73) Assignee: SANYO ELECTRIC CO., LTD., Osaka (JP)

(21) Appl. No.: 13/250,228

(22) Filed: Sep. 30, 2011

(30) Foreign Application Priority Data
Sep. 30, 2010 (JP) 2010-221678

(51) Int. Cl. H01M 4/13; H01M 10/04; H01M 4/139

(52) U.S. Cl. 429/229; 29/623.5; 29/623.1

(57) ABSTRACT

A method for producing a nonaqueous electrolyte secondary battery including a positive electrode containing a positive electrode active material, a negative electrode containing a negative electrode active material, and a nonaqueous electrolyte, the negative electrode active material containing a carbon material and particles of at least one metal selected from zinc and aluminum. The method includes a step of preparing an aqueous negative electrode mixture slurry that contains the metal particles, the carbon material, and a polysaccharide polymer as a thickener and that has pH adjusted in the range of 6.0 to 9.0; and a step of forming a negative electrode by applying the negative electrode mixture slurry to a negative electrode current collector.

### CROSS REFERENCE TO RELATED APPLICATIONS

The present invention claims priority to Japanese Patent Application No. 2010-221678 filed in the Japan Patent Office on Sep. 30, 2010, the entire contents of which are incorporated herein by reference.

### BACKGROUND OF THE INVENTION

1. Field of the Invention

The present invention relates to a method for producing a nonaqueous electrolyte secondary battery using an aqueous negative electrode mixture slurry containing particles of at least one metal selected from the group consisting of zinc and aluminum, and a nonaqueous electrolyte secondary battery.

2. Description of Related Art

In recent years, nonaqueous electrolyte secondary batteries in which charge and discharge are performed by moving lithium ions between a positive electrode and a negative electrode have been used as power supplies for mobile electronic devices.

Also, in recent years, reduction in size and weight of mobile devices such as mobile phones, notebook-size personal computers, PDA (Personal Digital Assistant), etc. has significantly advanced, and power consumption has been increased with the addition of multifunctions. In addition, there has been an increasing demand for nonaqueous electrolyte secondary batteries used as power supplies of these devices to have a high capacity and high energy density.

In the nonaqueous electrolyte secondary batteries, lithium cobaltate LiCoO₂, spinel lithium manganate LiMn₂O₄, a lithium-cobalt-nickel-manganese composite oxide, a lithium-aluminum-nickel-manganese composite oxide, and a lithium-aluminum-nickel-cobalt composite oxide are known as positive electrode active materials for positive electrodes. In addition, metallic lithium, carbon such as graphite, and materials which alloy with lithium, such as silicon and tin as described in the Journal of Electrochemical Society 150 (2003) A679 (Non-Patent Document 1) are known as negative electrode active materials for negative electrodes.

When metallic lithium is used as a negative electrode active material, it is difficult to handle and the formation of needle-shaped dendrites composed of metallic lithium occurs by charge and discharge, thereby causing internal short-circuit between the negative electrode and a positive electrode. Therefore, there are problems with battery life, safety, etc.

When a carbon material is used as a negative electrode active material, dendrites do not occur. In particular, use of graphite among carbon materials has the advantages of excellent chemical durability and structural stability, a high capacity per unit mass, high reversibility of lithium occlusion/release reaction, a low action potential, and excellent flatness. Therefore, graphite is often used for power supplies of mobile devices.

However, graphite has the problem that the theoretical capacity of intercalation complex LiC₆ is 372 mAh/g. Thus, it is impossible to sufficiently comply with the above-described demand for a high capacity and high energy density.

In order to produce a nonaqueous electrolyte secondary battery having a high capacity and high energy density using graphite, a negative electrode mixture containing graphite having a scaly primary particle shape is strongly compressed and bonded to a current collector to increase the packing density of the negative electrode mixture, thereby increasing the volume specific capacity of the nonaqueous electrolyte secondary battery.

However, in this case, when the packing density is increased by compressing the negative electrode mixture containing graphite, the graphite having a scaly primary particle shape is excessively oriented during compression, thereby causing the problems of decreasing the ionic diffusion rate in the negative electrode mixture to decrease the discharge capacity and increasing the action potential during discharge to decrease the energy density.

In addition, Si or a Si alloy has recently been proposed as a negative electrode active material having a high capacity density and high energy density in terms of mass ratio. Such a material exhibits a high specific capacity per unit mass of 4198 mAh/g in terms of Si. However, the material has the problem that the action potential at the time of discharge is higher than that of a graphite negative electrode, and volumetric expansion/contraction occurs during charge and discharge, resulting in deterioration in cycling characteristics.

Besides the above-described silicon (Si), zinc (Zn) and aluminum (Al) are known as elements that alloy with lithium to exhibit a high charge/discharge capacity. The theoretical capacity densities of zinc and aluminum are 410 mAh/g and 993 mAh/g, respectively, and are lower than the theoretical capacity density of silicon.

The inventors have found that when a packing density of a negative electrode mixture is increased by compressing it, a high charge/discharge capacity and good cycling characteristics can be achieved by using, as a negative electrode active material, a carbon material, such as graphite, in combination with zinc or aluminum that shows smaller volumetric expansion/contraction than silicon during charge/discharge. A technique of combining a carbon material and an element that alloys with lithium is disclosed in Japanese Published Unexamined Patent Application Nos. 2004-213927 (Patent Document 1) and 2000-113877 (Patent Document 2).

Patent Document 1 discloses the use of a negative electrode material containing a carbonaceous material, a graphite material, and metal nano fine particles having an average particle diameter of 10 nm or more and 200 nm or less and composed of a metal element selected from Ag, Zn, Al, Ga, In, Si, Ge, Sn, and Pb.

Patent Document 1 also discloses that by using the metal nano fine particles having a very small average particle diameter from the beginning, the influence of reduction in size of the particles due to expansion/contraction accompanying charge and discharge is suppressed, thereby improving cycling characteristics.

Patent Document 2 discloses the use of a mixture of graphite and a conductive aid containing carbon particles which hold a metal that forms an alloy with lithium. Also, Patent Document 2 discloses that the carbon particles which hold the metal particles have a smaller particle diameter than the graphite.

However, Patent Documents 1 and 2 use an organic solvent-based slurry and do not disclose a problem with use of an aqueous slurry and do not disclose a method for resolving the problem.

### BRIEF SUMMARY OF THE INVENTION

An object of the present invention is to provide a method for producing a nonaqueous electrolyte secondary battery by forming a negative electrode using an aqueous negative electrode mixture slurry which contains particles of at least one metal selected from the group consisting of zinc and aluminum, the method being capable of suppressing the occurrence of aggregates when the negative electrode is formed. An object of the present invention is also to provide a nonaqueous electrolyte secondary battery.

The present invention provides a method for producing a nonaqueous electrolyte secondary battery including a positive electrode containing a positive electrode active material, a negative electrode containing a negative electrode active material, and a nonaqueous electrolyte, the negative electrode active material containing a carbon material and particles of at least one metal selected from the group consisting of zinc and aluminum. The method includes a step of preparing an aqueous negative electrode mixture slurry which contains the metal particles, a carbon material, and a polysaccharide polymer as a thickener and which has pH adjusted in a range of 6.0 to 9.0, and a step of forming the negative electrode by applying the negative electrode mixture slurry to a negative electrode current collector.

According to an embodiment of the production method according to the present invention, it is possible to suppress the occurrence of aggregates when a negative electrode is formed and to produce a nonaqueous electrolyte secondary battery having a high capacity, a high energy density, and excellent charge/discharge cycling characteristics.

According to the present invention, the pH is preferably adjusted in the range of 6.0 to 9.0 by adding a pH buffer component to the negative electrode mixture slurry.

The negative electrode mixture slurry containing the polysaccharide polymer preferably contains the pH buffer component before the metal particles are added.

As the pH buffer component, a phosphate buffer component, for example, a buffer component containing potassium dihydrogen phosphate, can be used.

In an embodiment of the present invention, the polysaccharide polymer used as the thickener is, for example, a carboxymethylcellulose compound.

In the present invention, the average particle diameter of the metal particles is preferably in the range of 0.5 μm to 50 μm.

The metal particles are preferably formed by an atomization method.

A nonaqueous electrolyte secondary battery according to the present invention includes a positive electrode containing a positive electrode active material, a negative electrode containing a negative electrode active material, and a nonaqueous electrolyte. The negative electrode includes a negative electrode active material layer provided on a negative electrode current collector, the negative electrode active material layer containing particles of at least one metal selected from zinc and aluminum, a carbon material, a polysaccharide polymer, and a pH buffer component.

According to an embodiment of the present invention, in a method for producing a nonaqueous electrolyte secondary battery by forming a negative electrode using an aqueous negative electrode mixture slurry that contains particles of at least one metal selected from zinc and aluminum, it is possible to suppress the occurrence of aggregates when the negative electrode is formed. Therefore, a nonaqueous electrolyte secondary battery having a high capacity, a high energy density, and excellent charge/discharge cycling characteristics can be produced.

### BRIEF DESCRIPTION OF THE SEVERAL VIEWS OF THE DRAWINGS

FIG. 1 is a drawing showing a 10,000-times magnified SEM (scanning electron microscope) image of zinc particles used in an example according to the present invention;

FIG. 2 is a schematic sectional view showing a test cell formed in an example according to the present invention;

FIG. 3 is a drawing showing a 5,000-times magnified SEM image of a surface of a negative electrode formed in Example 1 according to the present invention;

FIG. 4 is a drawing showing a 5,000-times magnified SEM reflection electron image of a surface of a negative electrode formed in Example 1 according to the present invention;

FIG. 5 is a drawing showing a 5,000-times magnified SEM image of a surface of a negative electrode formed in Example 2 according to the present invention;

FIG. 6 is a drawing showing a 5,000-times magnified SEM reflection electron image of a surface of a negative electrode formed in Example 2 according to the present invention;

FIG. 7 is a drawing showing a 5,000-times magnified SEM image of a surface of a negative electrode formed in Comparative Example 1 according to the present invention; and

FIG. 8 is a drawing showing a 5,000-times magnified SEMI reflection electron image of a surface of a negative electrode formed in Comparative Example 1.

### DETAILED DESCRIPTION OF THE INVENTION

The present invention is described in further detail below.

### [Preparation of Negative Electrode Mixture Slurry]

A negative electrode mixture slurry of the present invention is an aqueous slurry having pH adjusted in the range of 6.0 to 9.0 and containing metal particles, a carbon material, and a polysaccharide polymer serving as a thickener.

The metal particles, the carbon material, and the polysaccharide polymer are described below.

### <Metal Particles>

The metal particles used in the present invention are composed of at least one metal selected from the group consisting of zinc and aluminum.

The average particle diameter of the metal particles is preferably in the range of 0.5 μm to 50 μm and more preferably in the range of 1 μm to 20 μm.

Zinc and aluminum have a higher ionization tendency than hydrogen. Therefore, with a small average particle diameter, it is difficult to produce the metal particles and the specific surface area is increased. As a result, the surface may be easily oxidized in air, thereby failing to achieve sufficient battery characteristics due to inactivation of the metal.

On the other hand, with an excessively large average particle diameter, the metal particles are settled when the negative electrode mixture slurry is formed, and thus the metal particles are not uniformly dispersed in the negative electrode mixture. As a result, the effect of mixing of the metal particles with the carbon material may not be sufficiently obtained.

The metal particles used in the present invention are preferably formed by an atomization method. The atomization method makes easy control of the average particle diameter and easy reduction in size of the particles, and thus the metal particles can be easily dispersed in a negative electrode mixture layer. In addition, the atomization method eliminates the need for a grinding step.

The metal particles are more preferably formed by a gas atomization method using inert gas. The gas atomization method using inert gas can suppress the formation of oxides such as zinc oxide or aluminum oxide on the surfaces of the particles and can form spherical metal particles. Therefore, the specific surface per unit volume can be decreased. Further, the metal particles can be uniformly dispersed in a matrix of the carbon material, thereby reducing the stress produced in an electrode due to a difference in expansion/contraction from the carbon material mixed, such as graphite, during charge and discharge. Therefore, the electrode structure can be stably maintained in repetition of charging and discharging, and cycling life characteristics can be improved.

### <Carbon Material>

Examples of the carbon material used in the present invention include graphite, petroleum coke, coal-derived coke, carbides of petroleum pitch, carbides of coal-derived pitch, phenol resins, carbides of crystalline cellulose resins and carbon produced by partial carbonization of the carbides, furnace black, acetylene black, pitch-based carbon fibers, PAN-based carbon fibers, and the like. From the viewpoint of conductivity and capacity density, graphite is preferably used.

The graphite preferably has a crystal lattice constant of 0.337 nm or less and as high crystallinity as possible because the conductivity and capacity density are high, and the action potential is decreased, thereby increasing the action voltage as a battery.

When the carbon material has a lame particle diameter, contact with the metal is decreased, and conductivity on the negative electrode is decreased. On the other hand, when the particle diameter is excessively small, the specific surface is increased to increase the number of inactive sites, thereby decreasing the efficiency of charge/discharge. Therefore, in an embodiment of the present invention, the average particle diameter of the carbon material is preferably in the range of 0.1 μm to 30 μm and more preferably in the range of 1 μm to 30 μm.

### <Mixing of Metal Particles and Carbon Material>

With respect to the mixing ratio of the metal particles to the carbon material, the ratio of the metal particles to the total of the metal particles and the carbon material is preferably in the range of 1 to 60% by mass, more preferably in the range of 10 to 50% by mass.

In the use of a mixture of the metal particles and the carbon material as the negative electrode active material, even when the packing density of the negative electrode is increased, partial spaces are formed between the metal particles and the carbon material, thereby improving nonaqueous electrolyte permeability. That is, when the mixture of the metal particles and the carbon material is used, lithium alloys with the metal particles to cause a proper degree of expansion and contraction during initial charge, and thus cracks, i.e., electrolytic solution paths, can be formed in the negative electrode. Therefore, the nonaqueous electrolyte permeability is improved. As a result, a nonaqueous electrolyte secondary battery having a high capacity, a high energy density, and excellent charge/discharge cycling properties can be produced.

When the content of the metal particles is excessively small, the effect of mixing with the metal particles may not be sufficiently obtained. When the content of the metal particles is excessively large, excessive growth of cracks or breakage of the negative electrode structure may occur.

In order to uniformly disperse the metal particles in the negative electrode mixture, the metal particles and the carbon material are mechanically mixed using a stirring device or a kneading device such as a mortar, a ball mill, a mechanofusion, or a jet mill.

### <Polysaccharide Polymer>

In the present invention, the aqueous negative electrode mixture slurry is prepared. A thickener suitable for aqueous slurry is used. In the present invention, the polysaccharide polymer is used as the thickener.

Examples of the polysaccharide polymer include carboxymethyl cellulose compounds, cellulose compounds, amylose compounds, amylopectin compounds, and the like. In particular, the carboxymethyl cellulose compounds are preferred because of the excellent thickening properties.

The content of the polysaccharide polymer in the negative electrode mixture slurry is appropriately controlled according to the types, the contents etc. of the metal particles and the carbon material.

Carboxymethyl cellulose sodium salt (hereinafter, referred to as “CMC”) as a polysaccharide polymer may be used as a mixture with styrene-butadiene rubber emulsion (hereinafter, referred to as “SBR”) as a binder.

### <pH Adjustment>

In the present invention, the pH of the aqueous negative electrode mixture slurry containing the metal particles, the carbon material, and the polysaccharide polymer is adjusted in the range of 6.0 to 9.0. The pH adjustment method is not particularly limited, but a method of adding a pH buffer component to the negative electrode mixture slurry is preferably used.

Examples of the pH buffer component include a phosphate buffer component, a pH buffer component using tris(hydroxymethyl)methylamine, and a pH buffer component using citric acid. In the present invention, the phosphate buffer component is preferably used.

Examples of a pH buffer component containing potassium dihydrogen phosphate include a pH 7.0 buffer component containing potassium dihydrogen phosphate and sodium hydroxide, a buffer component used as a pH 6.86 standard solution containing potassium dihydrogen phosphate and disodium hydrogen phosphate, and the like.

The content of the pH buffer component in the negative electrode mixture slurry is appropriately adjusted so that the pH of the negative electrode mixture slurry is in the range of 6.0 to 9.0.

### <Preparation of Negative Electrode Mixture Slurry>

The negative electrode mixture slurry used in the present invention contains the metal particles, the carbon material, and the polysaccharide polymer, and is adjusted in the pH range of 6.0 to 9.0. As described above, the pH is adjusted in the range of 6.0 to 9.0 by adding the pH buffer component. In this case, the pH buffer component is preferably contained in the negative electrode mixture slurry containing the polysaccharide polymer before the metal particles are added to the negative electrode mixture slurry. When the pH buffer component is contained in the negative electrode mixture slurry before the metal particles are added, an increase in pH can be suppressed when the metal particles are added to the slurry. That is, the metal particles used in the present invention have a higher ionization tendency than hydrogen, and thus when the metal particles are added to the slurry containing water as a dispersant, the metal particles react with water to generate hydrogen and increase the pH of the slurry. An increase in pH of the slurry causes the occurrence of aggregates due to aggregation of the polysaccharide polymer. According to an embodiment of the present invention, the occurrence of aggregate slurry can be efficiently suppressed by suppressing an increase in pH of the slurry.

### <Formation of Negative Electrode>

In an embodiment of the present invention, the negative electrode can be formed by applying the negative electrode mixture slurry prepared as described above to a current collector, for example, one including a copper foil and then drying the slurry.

Further, after drying, the negative electrode is preferably rolled with a rolling roller.

The packing density of the negative electrode is preferably 1.7 g/cm³ or more, more preferably 1.8 g/cm³ or more, and still more preferably 1.9 g/cm³ or more. By increasing the packing density of the negative electrode, the negative electrode having a high capacity and high energy density can be formed. According an embodiment of to the present invention, even when the packing density of the negative electrode is increased, good charge/discharge cycling characteristics can be achieved because of the excellent nonaqueous electrolyte permeability.

The upper limit of the packing density of the negative electrode is not particularly limited, but is preferably 3.0 g/cm³ or less.

### [Positive Electrode]

As the positive electrode active material used for the positive electrode of the present invention, active materials generally used for nonaqueous electrolyte secondary batteries can be used. Examples thereof include lithium-cobalt composite oxides (for example, LiCoO₂), lithium-nickel composite oxides (for example, LiNiO₂), lithium-manganese composite oxides (for example, LiMn₂O₄ and LiMnO₂), lithium-nickel-cobalt composite oxides (for example, LiNi₁₋ₓCOₓO₂), lithium-manganese-cobalt composite oxides (for example, LiMn₁₋ₓCOₓO₂), lithium-nickel-cobalt-manganese composite oxides (for example, LiNiₓCO_{y}Mn_{z}O₂ (x+y+z=1)), lithium-nickel-cobalt-aluminum composite oxides (for example, LiNiₓCO_{y}Al_{z}O₂ (x+y+z=1)), lithium transition metal oxides, manganese dioxide (for example, MnO₂), polyphosphorus oxides such as LiFePO₄ and LiMPO₄ (M is a metal element), metal oxides such as vanadium oxide (for example, V₂O₅), and other oxides, sulfides, and the like.

In order to increase the capacity density of the battery by combining the positive electrode with the negative electrode, it is preferred to use, as the positive electrode active material of the positive electrode, a lithium-cobalt composite oxide containing cobalt with a high action potential, for example, lithium cobaltate LiCoO₂, a lithium-nickel-cobalt composite oxide, a lithium-nickel-cobalt-manganese composite oxide, a lithium-manganese-cobalt composite oxide, or a mixture thereof. In order to produce the battery having a high capacity, a lithium-nickel-cobalt composite oxide or a lithium-nickel-cobalt-manganese composite oxide is more preferably used.

The material for a positive electrode current collector on the positive electrode is not particularly limited as long as it is a conductive material. For example, aluminum, stainless, and titanium can be used. In addition, for example, acetylene black, graphite, and carbon black can be used as the conductive material, and for example, polyvinylidene fluoride, polytetrafluoroethylene, EPDM, SBR, NBR, and fluorocarbon rubber can be used as the binder.

### [Nonaqueous Electrolyte]

As the nonaqueous electrolyte used in the present invention, nonaqueous electrolytes generally used for nonaqueous electrolyte secondary batteries can be used. For example, a nonaqueous electrolytic solution containing a solute dissolved in a nonaqueous solvent and a gel polymer electrolyte produced by impregnating a polymer electrolyte, such as polyethylene oxide or polyacrylonitrile, with the nonaqueous electrolytic solution can be used.

As the nonaqueous solvent, nonaqueous solvents generally used for nonaqueous electrolyte secondary batteries can be used. For example, cyclic carbonate and chain carbonate can be used. Examples of the cyclic carbonate which can be used include ethylene carbonate, propylene carbonate, butylene carbonate, vinylene carbonate, and fluorine derivatives thereof. Preferably, ethylene carbonate or fluoroethylene carbonate is used. Examples which can be used as the chain carbonate include dimethyl carbonate, methylethyl carbonate, diethyl carbonate, and fluorine derivatives thereof. Also, a mixed solvent prepared by mixing two or more nonaqueous solvents can be used. A mixed solvent containing cyclic carbonate and chain carbonate is preferably used. In particular, when the negative electrode including the negative electrode mixture with a high packing density is used, a mixed solvent containing cyclic carbonate at a mixing ratio of 35% by volume or less is preferably used for increasing permeability to the negative electrode. Further, a mixed solvent containing the cyclic carbonate and an ether solvent, such as 1,2-dimethoxyethane or 1,2-diethoxyethane, can be preferably used.

Also, as the solute, solutes generally used for nonaqueous electrolyte secondary batteries can be used. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, Li₂B₁₂Cl₁₂, and the like can be used alone or in combination of two or more.

### EXAMPLES

The present invention is described below with reference to examples, but the present invention is not limited to these examples.

### Example 1

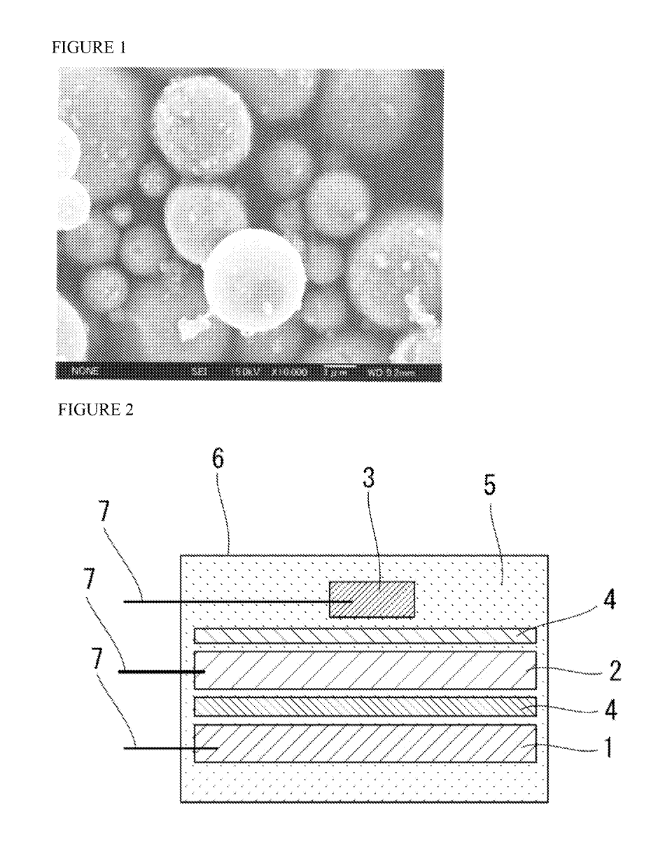

Zinc spherical particles (manufactured by Kishida Chemical Co., Ltd., special grade, part No. 000-87575) having an average particle diameter of 4.5 μm and produced by the atomization method were used as a first active material. FIG. 1 shows a SEM (Scanning Electron Microscope) image of the zinc particles used.

Artificial graphite having an average particle diameter of 22 μm and a crystal lattice constant of 0.3362 nm was used as a second active material.

The average particle diameters of the zinc particles and the artificial graphite were measured using a laser diffraction particle size distribution analyzer (SALAD-2000 manufactured by Shimadzu Corporation).

The first active material and the second active material were mixed at a mass ratio (first active material:second active material) of 10:90.

A pH 7.0 buffer solution (pH buffer solution manufactured by Kishida Chemical Co., Ltd.) containing 0.12% by mass of sodium hydroxide (NaOH) and 0.68% by mass of potassium dihydrogen phosphate (KH₂PO₄) was mixed with an aqueous solution containing 1.0 part by mass of carboxymethyl cellulose (CMC) sodium salt to prepare a mixed solution.

The mixture of the first active material and the second active material at the above-described mixing ratio was mixed with a styrene-butadiene rubber (SBR) emulsion (solid content 48.5% by mass) at a mass ratio of 97.5:1.5 to prepare a dispersion solution. The mixed solution prepared as described above was mixed with the resultant dispersion solution so that the mass ratio of (total of the first active material and the second active material:CMC:SBR) was 97.5:1.0:1.5, and the resultant mixture was kneaded to prepare a negative electrode mixture slurry.

The pH buffer component was added in an amount of 0.5 g relative to 1 g of the slurry solid content (active materials, CMC, and SBR). The measured pH of the negative electrode mixture slurry is shown in Table 1.

Next, the negative electrode mixture slurry was applied to a negative electrode current collector including a copper foil, dried at 80° C., and then rolled with a rolling roller. Then, a current collector tab was attached to form a negative electrode.

### [Measurement of Number of Aggregates in Electrode]

The number of aggregates having a diameter of 1 mm or more was measured by observing the surface of the resultant negative electrode. The number of aggregates per 10 cm² is shown in Table 1.

### <Formation of Test Cell>

A test cell shown in FIG. 2 was formed using the negative electrode. In a glove box under an argon atmosphere, the test cell was formed using the negative electrode as a working electrode 1 and a lithium metal for each of a counter electrode 2 and a reference electrode 3. An electrode tab 7 was attached to each of the working electrode 1, the counter electrode 2, and the reference electrode 3. The working electrode 1, the counter electrode 2, and the reference electrode 3 with polyethylene separators provided between the working electrode 1 and the counter electrode 2 and between the counter electrode 2 and the reference electrode 3 were sealed, together with a nonaqueous electrolytic solution 5, in a laminate container 6 composed of an aluminum laminate, thereby forming test cell A1.

The nonaqueous electrolytic solution 5 used was prepared by dissolving lithium hexafluorophosphate (LiPF₆) at a concentration of 1 mol/liter in a mixed solvent containing ethylene carbonate and ethylmethyl carbonate at a volume ratio of 3:7.

### [Measurement of Initial Discharge Capacity and Discharge Capacity at 5th Cycle]

The test cell formed as described above was, at room temperature, charged until the potential reached 0 V (vs. Li/Li⁺) with a constant current of 0.2 mA/cm² and then discharged until the potential reached 1.0 V (vs. Li/Li⁺) with a constant current of 0.2 mA/cm². The initial discharge capacity at the 1st cycle and the discharge capacity at the 5th cycle after repetition of the charge/discharge cycle were determined. The results are shown in Table 1.

### Example 2

A negative electrode was formed by the same method as in Example 1 except that the mixing ratio of the buffer component was 1.0 g relative to 1 g of the slurry solid content, and test cell A2 was formed using the formed negative electrode.

The pH of the negative electrode mixture slurry, the number of aggregates in the electrode, the initial discharge capacity, and the discharge capacity at the 5th cycle were measured. The results are shown in Table 1.

### Comparative Example 1

A negative electrode was formed by the same method as in Example 1 except that the pH buffer component was not mixed when the negative electrode mixture slurry was prepared, and test cell X1 was formed using the formed negative electrode.

The pH of the negative electrode mixture slurry, the number of aggregates in the electrode, the initial discharge capacity, and the discharge capacity at the 5th cycle were measured. The results are shown in Table 1. In Table 1, the amount of the pH buffer component mixed represents the ratio by mass of the pH buffer component to the solid content in the negative electrode mixture slurry.

TABLE 1

| | | Negative electrode active | | | Amount of | pH of negative | Number of | Initial | Discharge |
|---|---|---|---|---|---|---|---|---|---|
| | | material (ratio by mass) | | | pH buffer | electrode | aggregates | discharge | capacity at |
| | | First active | Second Active | pH buffer | component | mixture | in electrode | capacity | 5th cycle |
| | Cell | material | material | component | mixed | slurry | (/10 cm²) | (mAh/g) | (mAh/g) |
| Example 1 | A1 | Zn (10) | Artificial | pH 7.0 | 0.5 | 7.88 | 0 | 312.0 | 322.8 |
| | | | graphite (90) | buffer | | | | | |
| Example 2 | A2 | Zn (10) | Artificial | pH 7.0 | 1.0 | 7.47 | 0 | 314.1 | 321.1 |
| | | | graphite (90) | buffer | | | | | |
| Comparative | X1 | Zn (10) | Artificial | 0 | 0 | 11.16 | >100 | 300.8 | 316.1 |
| Example 1 | | | graphite (90) | | | | | | |

Table 1 indicates that in Comparative Example 1 in which the pH buffer component was not added to the negative electrode mixture slurry, the pH of the negative electrode mixture slurry is 11.16. On the other hand, in Examples 1 and 2 in which the pH buffer component was added to the negative electrode mixture slurry, the pHs of the negative electrode mixture slurries are 7.88 and 7.47, respectively. In Examples 1 and 2 in which the pH of the negative electrode mixture slurry was adjusted in the range of 6.0 to 9.0 according to the present invention, as shown in Table 1, the number of aggregates in the electrode is 0. While in Comparative Example 1, the number of aggregates is more than 100.

Therefore, it is found that when the pH of the negative electrode slurry is adjusted in the range of 6.0 to 9.0 according to the present invention, an increase in pH can be suppressed when zinc particles are added, and thus aggregation of the polysaccharide polymer due to an increase in pH can be suppressed.

Table 1 also indicates that in Examples 1 and 2, the initial discharge capacity and the discharge capacity at the 5th cycle are more improved than in Comparative Example 1. Therefore, it is found that when the pH of the negative electrode slurry is adjusted in the range of 6.0 to 9.0 according to the present invention, the occurrence of aggregates can be suppressed when the negative electrode is formed, and thus a nonaqueous electrolyte secondary battery having a high capacity, a high energy density, and excellent charge/discharge cycling characteristics can be produced.

### <SEM Observation of Surface of Negative Electrode>

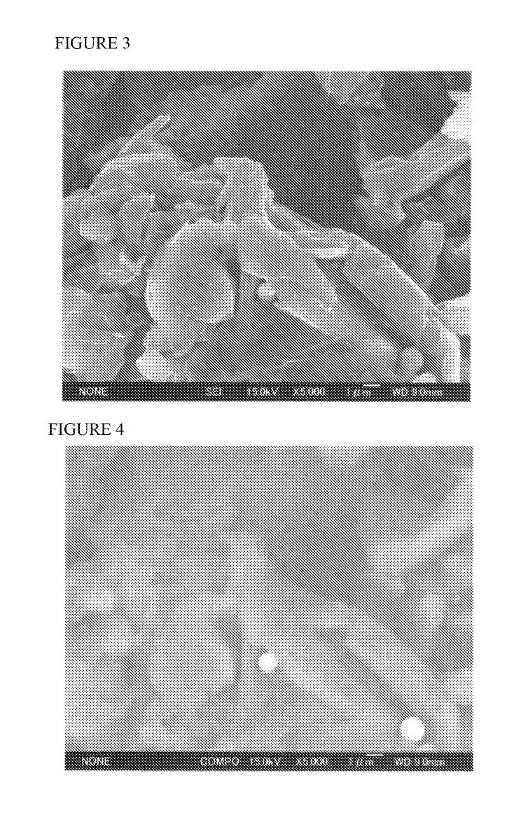

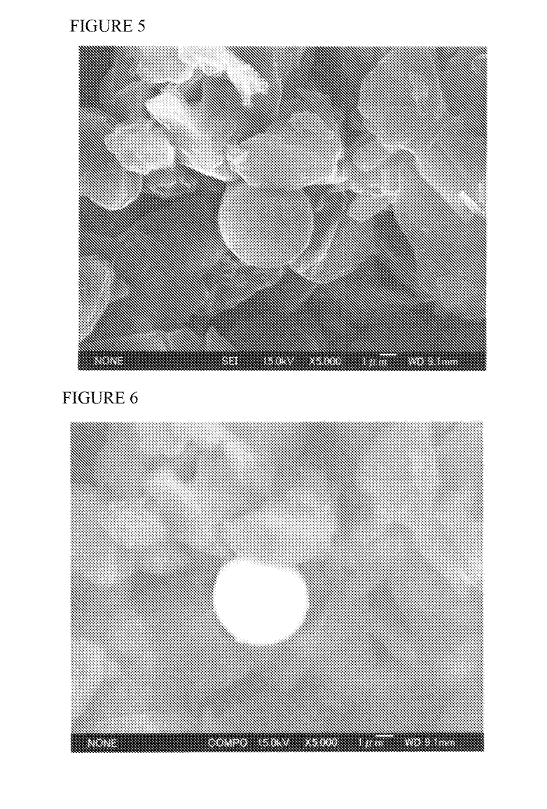

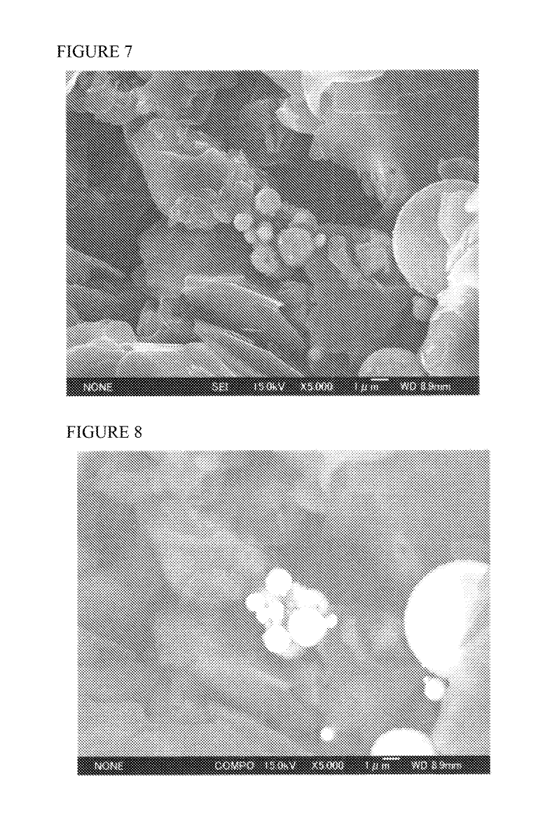

The surfaces of the negative electrodes formed in Examples 1 and 2 and Comparative Example 1 were observed with SEM. FIGS. 3, 5, and 7 show 5000-times magnified SEM images of the surfaces of the negative electrodes formed in Examples 1 and 2 and Comparative Example 1, respectively. FIGS. 4, 6, and 8 show 5000-times magnified SEM reflection electron images of the surfaces of the negative electrodes formed in Examples 1 and 2 and Comparative Example 1, respectively. In each of the SEM reflection electron images, zinc particles are shown in white, and graphite particles are shown in black.

FIGS. 3 to 8 indicate that in Comparative Example 1, which does not contain the buffer component, the zinc particles and the graphite particles form aggregates, while in Examples 1 and 2, containing the pH buffer component according to the present invention, no aggregate is observed.

### Example 3

A negative electrode was formed by the same method as in Example 1 except that a pH standard solution (Kishida Chemical Co., Ltd.) including an aqueous solution containing 0.36% by mass of disodium hydrogen phosphate (Na₂HPO₄) and 0.68% by mass of potassium dihydrogen phosphate (KH₂PO₄) was used as the pH buffer component and mixed in an amount of 1.0 g relative to 1 g of the solid content in the negative electrode mixture slurry.

The pH of the negative electrode mixture slurry and the number of aggregates in the electrode were measured by the same method as in Example 1. The results are shown in Table 2.

TABLE 2

| | Negative electrode active | | | Amount of | pH of negative | Number of |
|---|---|---|---|---|---|---|
| | material (ratio by mass) | | | pH buffer | electrode | aggregates |
| | First active | Second active | pH buffer | component | mixture | in electrode |
| | material | material | component | mixed | slurry | (/10 cm²) |
| Example 3 | Zn (10) | Artificial | pH 6.86 standard | 1.0 | 8.50 | 0 |
| | | graphite (90) | solution | | | |
| Comparative | Zn (10) | Artificial | 0 | 0 | 11.16 | >100 |
| Example 1 | | graphite (90) | | | | |

Table 2 indicates that in Example 3 in which the pH buffer component was added to the negative electrode mixture slurry, the pH of the negative electrode mixture slurry is 8.50, and the number of aggregates in the electrode is 0. In contrast, in Comparative Example 1 in which the pH buffer component was not added to the negative electrode mixture slurry, the pH of the negative electrode mixture slurry is 11.16, and the number of aggregates in the electrode is more than 100.

These results indicate that when the pH of the negative electrode mixture slurry is adjusted in the range of 6.0 to 9.0 according to the present invention, the occurrence of aggregation of the polysaccharide polymer and aggregates of the metal particles and the carbon material in the negative electrode can be suppressed. The aggregates of the metal particles and the carbon material are considered to be produced by aggregation of the polysaccharide polymer. According to the present invention, an increase in pH can be suppressed when the metal particles are added to the negative electrode mixture slurry, and thus aggregation of the polysaccharide polymer can be suppressed, thereby suppressing the occurrence of aggregation of the metal particles and the carbon material due to aggregation of the polysaccharide polymer. By suppressing aggregation of the metal particles and the carbon material, a nonaqueous electrolyte secondary battery having a high capacity, a high energy density, and excellent cycling characteristics can be produced.

In each of the examples, the negative electrode formed by the production method of the present invention was evaluated by forming the test cell using metallic lithium for the counter electrode, and. However, even when the negative electrode is incorporated as a negative electrode for a nonaqueous electrolyte secondary battery, the same results can be obtained.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method for producing a nonaqueous electrolyte secondary battery including a positive electrode containing a positive electrode active material, a negative electrode containing a negative electrode active material, and a nonaqueous electrolyte,
the negative electrode active material containing a carbon material and particles of at least one metal selected from the group consisting of zinc and aluminum,
the method comprising:
a step of preparing an aqueous negative electrode mixture slurry which contains the metal particles, the carbon material, and a polysaccharide polymer as a thickener and which has a pH adjusted in the range of 6.0 to 9.0; and
a step of forming the negative electrode by applying the negative electrode mixture slurry to a negative electrode current collector.

2. The method for producing a nonaqueous electrolyte secondary battery according to claim 1, wherein the pH is adjusted in the range of 6.0 to 9.0 by adding a pH buffer component to the negative electrode mixture slurry.

3. The method for producing a nonaqueous electrolyte secondary battery according to claim 2, wherein the negative electrode mixture slurry containing the polysaccharide polymer contains the pH buffer component before the metal particles are added.

4. The method for producing a nonaqueous electrolyte secondary battery according to claim 2, wherein the pH buffer component is a phosphate buffer component.

5. The method for producing a nonaqueous electrolyte secondary battery according to claim 3, wherein the pH buffer component is a phosphate buffer component.

6. The method for producing a nonaqueous electrolyte secondary battery according to claim 4, wherein the phosphate buffer component contains potassium dihydrogen phosphate.

7. The method for producing a nonaqueous electrolyte secondary battery according to claim 5, wherein the phosphate buffer component contains potassium dihydrogen phosphate.

8. The method for producing a nonaqueous electrolyte secondary battery according to claim 1, wherein the polysaccharide polymer is a carboxymethyl cellulose compound.

9. The method for producing a nonaqueous electrolyte secondary battery according to claim 2, wherein the polysaccharide polymer is a carboxymethyl cellulose compound.

10. The method for producing a nonaqueous electrolyte secondary battery according to claim 3, wherein the polysaccharide polymer is a carboxymethyl cellulose compound.

11. The method for producing a nonaqueous electrolyte secondary battery according to claim 4, wherein the polysaccharide polymer is a carboxymethyl cellulose compound.

12. The method for producing a nonaqueous electrolyte secondary battery according to claim 5, wherein the polysaccharide polymer is a carboxymethyl cellulose compound.

13. The method for producing a nonaqueous electrolyte secondary battery according to claim 6, wherein the polysaccharide polymer is a carboxymethyl cellulose compound.

14. The method for producing a nonaqueous electrolyte secondary battery according to claim 2, wherein the average particle diameter of the metal particles is in the range of 0.5 μm to 50 μm.

15. The method for producing a nonaqueous electrolyte secondary battery according to claim 3, wherein the average particle diameter of the metal particles is in the range of 0.5 μm to 50 μm.

16. The method for producing a nonaqueous electrolyte secondary battery according to claim 4, wherein the average particle diameter of the metal particles is in the range of 0.5 μm to 50 μm.

17. The method for producing a nonaqueous electrolyte secondary battery according to claim 12, wherein the average particle diameter of the metal particles is in the range of 0.5 μm to 50 μm.

18. The method for producing a nonaqueous electrolyte secondary battery according to claim 6, wherein the average particle diameter of the metal particles is in the range of 0.5 μm to 50 μm.

19. The method for producing a nonaqueous electrolyte secondary battery according to claim 1, wherein the metal particles are formed by an atomization method.

20. A nonaqueous electrolyte secondary battery comprising:
a positive electrode containing a positive electrode active material;
a negative electrode containing a negative electrode active material; and
a nonaqueous electrolyte,
wherein the negative electrode includes a negative electrode active material layer provided on a negative electrode current collector, and the negative electrode active material layer contains particles of at least one metal selected from the group consisting of zinc and aluminum, a carbon material, a polysaccharide polymer, and a pH buffer component.
